(19) United States
(12) Patent Application Publication
(10) Pub. No.: US 2025/0167308 A1
(43) Pub. Date: May 22, 2025

(54) APPARATUS AND METHOD FOR MANUFACTURING ELECTRODE

(71) Applicant: SAMSUNG SDI CO., LTD., Yongin-si (KR)

(72) Inventors: Seong Bong CHO, Suwon-si (KR); Jeong Ho KANG, Suwon-si (KR)

(21) Appl. No.: 18/952,905

(22) Filed: Nov. 19, 2024

(30) Foreign Application Priority Data
Nov. 21, 2023 (KR) 10-2023-0162363

(51) Int. Cl. H01M 10/0587; H01M 10/052

(52) U.S. Cl. CPC H01M 10/0587; H01M 10/052

(57) ABSTRACT

An electrode manufacturing apparatus and an electrode manufacturing method are disclosed. An electrode manufacturing apparatus includes: an electrode plate conveyor to convey an electrode plate; a first punching unit configured to punch a portion of the electrode plate conveyed by the electrode plate conveyor; and a second punching unit configured to punch another portion of the electrode plate punched by the first punching unit and conveyed by the electrode plate conveyor.

### CROSS-REFERENCE TO RELATED APPLICATION

The present application claims priority to and the benefit of Korean Patent Application No. 10-2023-0162363, filed on Nov. 21, 2023 in the Korean Intellectual Property Office, the entire disclosure of which is incorporated herein by reference.

### BACKGROUND

### 1. Field

Aspects of embodiments of the present invention relate to an apparatus and method for manufacturing an electrode.

### 2. Description of the Related Art

In recent years, demand for high-energy density and high-capacity secondary batteries has grown rapidly with rapid spread of electronic devices using batteries, such as mobile phones, notebook computers, and electric vehicles. Thus, various research and development has been actively carried out to improve lithium secondary batteries.

A lithium secondary battery includes a cathode, an anode, an electrolyte, and a separator interposed between the cathode and the anode that contain active materials allowing intercalation and deintercalation of lithium ions, and produces electrical energy through oxidation and reduction upon intercalation/deintercalation of lithium ions in the cathode and the anode.

An electrode including a cathode and/or an anode is manufactured by performing a process (e.g., a predetermined process) on an electrode plate. The electrode plate includes a current collector and an active material coated on at least part of at least one surface of the current collector. Here, a portion of the current collector coated with the active material is referred to as a coated portion, and a portion of the current collector not coated with the active material is referred to as an uncoated portion.

The electrode may be formed by punching the uncoated portion of the electrode plate to form a tab and/or by cutting the electrode plate at regular intervals.

This section is intended to provide a better understanding of the background of the invention and thus may include information which is not necessarily prior art.

### SUMMARY

According to aspects of embodiments of the present invention, an apparatus and method for manufacturing an electrode are provided.

For example, according to aspects of embodiments of the present invention, an apparatus and method for manufacturing an electrode, which can reduce maintenance costs and/or can secure improvement in life span thereof, are provided.

The above and other aspects and features of the present invention will become apparent from the following description of some embodiments of the present invention.

According to one or more embodiments of the present invention, an electrode manufacturing apparatus includes: an electrode plate conveyor to convey an electrode plate; a first punching unit configured to punch a portion of the electrode plate conveyed by the electrode plate conveyor; and a second punching unit configured to punch another portion of the electrode plate punched by the first punching unit and then conveyed by the electrode plate conveyer.

According to one or more embodiments of the present invention, an electrode manufacturing method includes: conveying an electrode plate through, or via, an electrode plate conveyor; punching a portion of the conveyed electrode plate through, or via, a first punching unit; and punching another portion of the electrode plate punched by the first punching unit and conveyed by the electrode plate conveyor through, or via, a second punching unit.

The electrode plate manufacturing apparatus and/or the electrode plate manufacturing method according to the embodiments may provide a method of separating and separately managing the first punching unit and the second punching unit.

For example, the electrode plate manufacturing apparatus and/or the electrode plate manufacturing method according to the embodiments can secure long life span of at least one of the first punching unit and the second punching unit, thereby reducing costs for regrinding the punching unit and maintenance costs.

However, aspects and features of the invention are not limited to those described above and other aspects and features not mentioned will be understood by those skilled in the art from the detailed description provided below.

### BRIEF DESCRIPTION OF THE DRAWINGS

The following drawings attached to this specification illustrate some embodiments of the present invention, and further describe aspects and features of the present invention together with the detailed description of the present invention. Thus, the present invention should not be construed as being limited to the drawings.

FIG. 1 to FIG. 4 are schematic views of lithium secondary batteries according to some embodiments of the present invention;

FIG. 5 is a view of a weak portion of a typical electrode manufacturing apparatus;

FIG. 6 is a flowchart illustrating an electrode manufacturing method according to an embodiment of the present invention;

FIG. 7 is a schematic cross-sectional view of an electrode manufacturing apparatus according to an embodiment of the present invention;

FIG. 8 is a schematic view of a punched electrode plate according to an embodiment of the present invention;

FIG. 9A to FIG. 9C are diagrams illustrating a process of manufacturing an electrode according to an embodiment of the present invention; and

FIG. 10 is a diagram illustrating a process of manufacturing an electrode according to an embodiment of the present invention.

### DETAILED DESCRIPTION

Herein, some example embodiments of the present invention will be described, in further detail, with reference to the accompanying drawings. The terms or words used in this specification and claims should not be construed as being limited to the usual or dictionary meaning and should be interpreted as having meanings and concepts consistent with the technical idea of the present invention based on the principle that the inventor can be his/her own lexicographer to appropriately define the concept of the term to explain his/her invention in the best way. The embodiments described in this specification and the configurations shown in the drawings are only some of the embodiments of the present invention and do not represent all of the technical ideas, aspects, and features of the present invention. Accordingly, it is to be understood that there may be various equivalents and modifications that can replace or modify the embodiments described herein at the time of filing this application. It is to be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof. Further, the use of “may” when describing embodiments of the present invention relates to “one or more embodiments of the present invention.”

In the figures, dimensions of the various elements, layers, etc. may be exaggerated for clarity of illustration. The same reference numerals designate the same elements.

References to two compared elements, features, etc. as being “the same,” may mean that they are the same or substantially the same. Thus, the phrase “the same” or “substantially the same” may include a case having a deviation that is considered low in the art, for example, a deviation of 5% or less. In addition, when a certain parameter is referred to as being uniform in a given region, it may mean that it is uniform in terms of an average.

It is to be understood that, although the terms “first,” “second,” “third,” etc. may be used herein to describe various elements, components, regions, layers, and/or sections, these elements, components, regions, layers, and/or sections are not to be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Throughout the specification, unless specified otherwise, each element may be singular or plural.

When an arbitrary element is referred to as being disposed (or located or positioned) “above” (or “below”) or “on” (or “under”) a component, it may mean that the arbitrary element is placed in contact with the upper (or lower) surface of the component and may also mean that another component or components may be interposed between the component and any arbitrary element disposed (or located or positioned) on (or under) the component.

In addition, it is to be understood that, when an element is referred to as being “coupled,” “linked,” or “connected” to another element, the elements may be directly “coupled,” “linked,” or “connected” to each other, or one or more intervening elements may be present therebetween, through which the element may be “coupled,” “linked,” or “connected” to the another element. In addition, when a part is referred to as being “electrically coupled” to another part, the part may be directly connected to another part or one or more intervening parts may be present therebetween such that the part and the another part are indirectly connected to each other.

Throughout the specification, when “A and/or B” is stated, it means A, B, or A and B, unless specified otherwise. That is, “and/or” includes any or all combinations of a plurality of items enumerated. When “C to D” is stated, it means C or more and D or less, unless specified otherwise.

The terminology used herein is for the purpose of describing embodiments of the present invention and is not intended to be limiting of the present invention.

### Lithium Secondary Battery

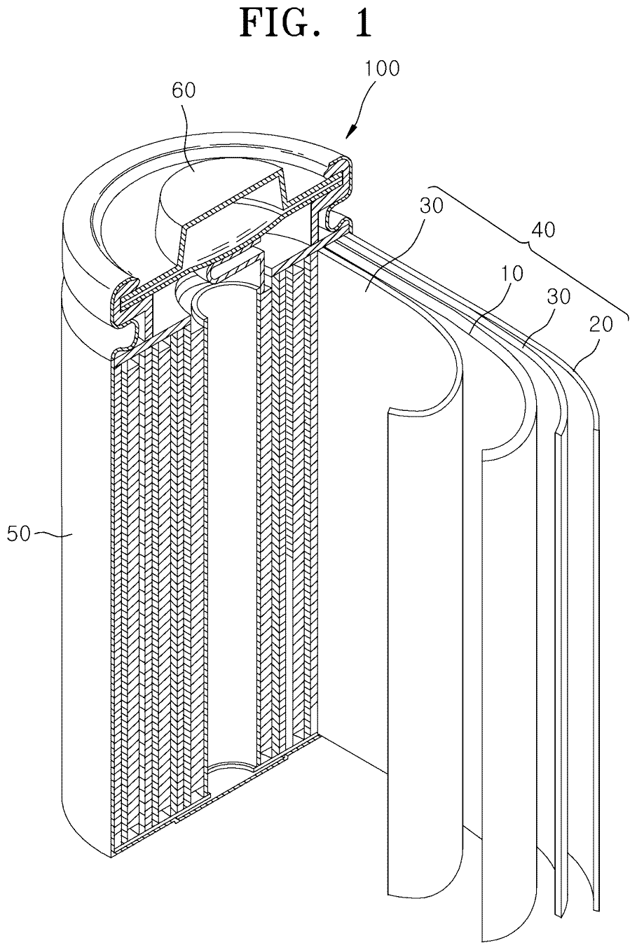

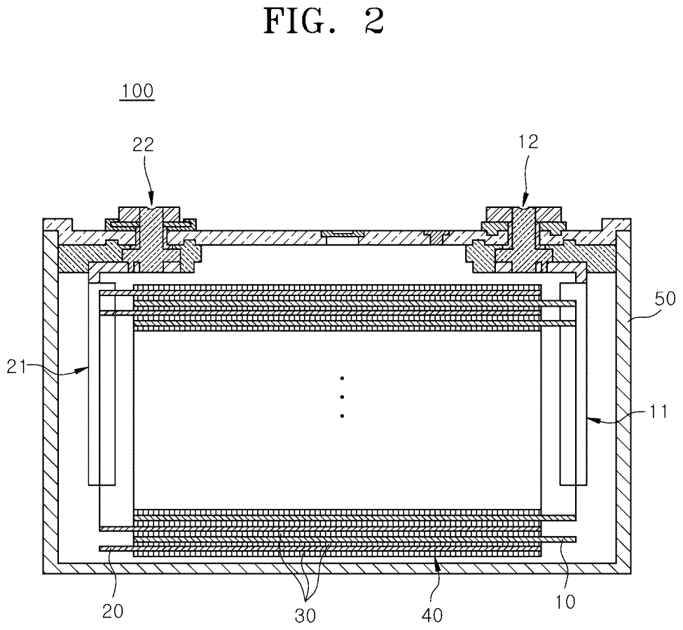

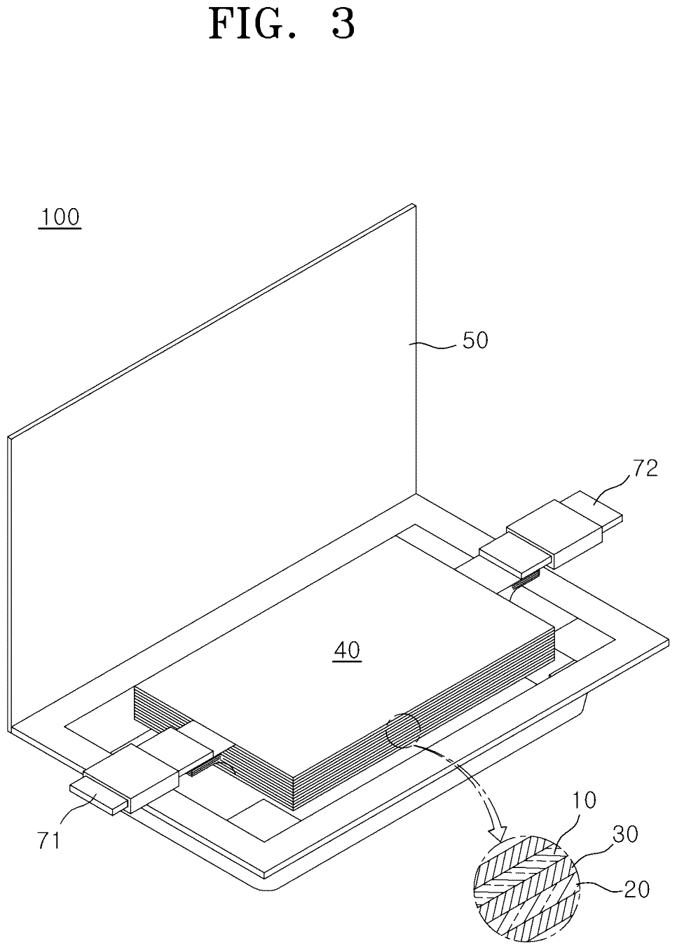

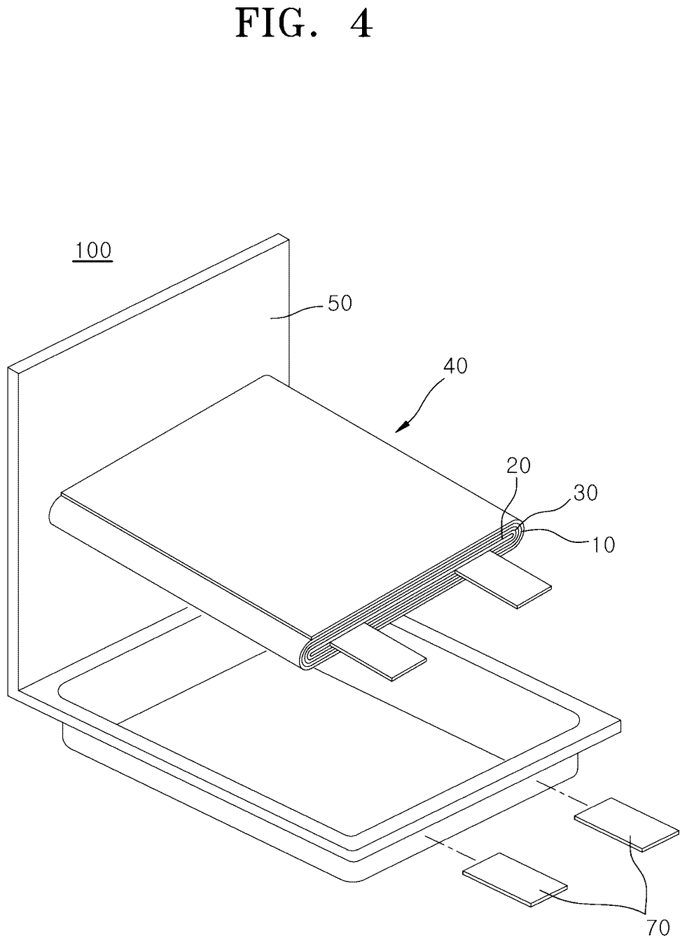

Lithium secondary batteries may be classified into a cylindrical secondary battery, a faceted secondary battery, a pouch type secondary battery, a coin type secondary battery, and the like, based on shapes thereof. FIG. 1 to FIG. 4 are schematic views of lithium secondary batteries according to some embodiments of the present invention, in which FIG. 1 shows a cylindrical secondary battery, FIG. 2 shows a faceted secondary battery, and FIG. 3 and FIG. 4 show pouch-type secondary batteries. Referring to FIG. 1 to FIG. 4, a lithium secondary battery 100 may include an electrode assembly 40 that includes a separator 30 interposed between a cathode 10 and an anode 20, and a case 50 that receives the electrode assembly 40 therein. The cathode 10, the anode 20, and the separator 30 may be embedded in an electrolyte (not shown). The lithium secondary battery 100 may include a sealing member 60 that seals the case 50, as shown in FIG. 1. In an embodiment, as shown in FIG. 2, a lithium secondary battery 100 may include a cathode lead tab 11, a cathode terminal 12, an anode lead tab 21, and an anode terminal 22. As shown in FIG. 3 and FIG. 4, a lithium secondary battery 100 may include electrode tabs 70, that is, a cathode tab 71 and an anode tab 72, which act as electrical pathways conducting current formed in the electrode assembly 40 to the outside.

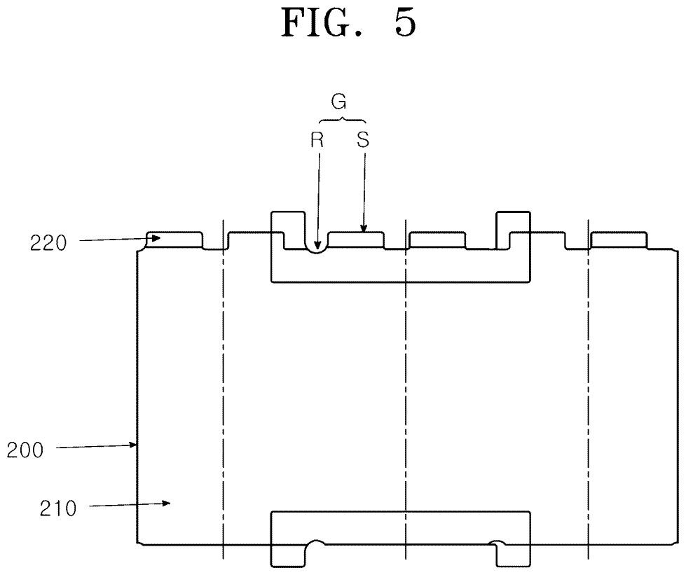

With reference to FIG. 1 to FIG. 4, schematic components and/or materials of the lithium secondary battery are described. Herein, referring to FIG. 5 to FIG. 10, a method of manufacturing the lithium secondary battery 100 described in FIG. 1 to FIG. 4 will be described. For example, referring to FIG. 5 to FIG. 10, a method and/or apparatus for manufacturing an electrode plate and/or an electrode included in the lithium secondary battery 100 described in FIG. 1 to FIG. 4 will be described.

FIG. 5 is a view of a weak portion of a typical electrode manufacturing apparatus.

In FIG. 5, reference numeral 200 denotes an electrode plate, and G denotes a typical electrode manufacturing device.

The electrode plate 200 includes an anode plate, which becomes an anode as described in FIG. 1 to FIG. 4, and a cathode plate, which become a cathode as described in FIG. 1 to 4.

The cathode plate may include a current collector and a cathode material layer formed on the current collector. The cathode material layer may include a cathode material and may further include a binder and/or a conductive material.

In an embodiment, the cathode may further include an additive that can act as a sacrificial cathode.

As the cathode material, a compound allowing reversible intercalation and deintercalation of lithium (lithiated intercalation compound) may be used. In an embodiment, the cathode material may be at least one complex oxide of a metal selected from among cobalt, manganese, nickel, and combinations thereof with lithium.

The composite oxide may be a lithium transition metal composite oxide. In an embodiment, the composite oxide may be a lithium nickel oxide, a lithium cobalt oxide, a lithium manganese oxide, a lithium iron phosphate compound, a cobalt-free nickel-manganese oxide, or a combination thereof.

By way of example, the composite oxide may be a compound represented by any of the following formulas: LiₐA_{1-b}X_{b}O_{2-c}D_{c} (0.90≤a≤1.8, 0≤b≤0.5, 0≤c≤0.05); LiₐMn_{2-b}X_{b}O_{4-c}D_{c} (0.90≤a≤1.8, 0≤b≤0.5, 0≤c≤0.05); LiₐNi_{1-b-c}CO_{b}X_{c}O₂₋ₐDₐ (0.90≤a≤1.8, 0≤b≤0.5, 0≤c≤0.5, 0<a<2); LiₐNi_{1-b-c}Mn_{b}X_{c}O₂₋ₐDₐ (0.90≤a≤1.8, 0≤b≤0.5, 0≤c≤0.5, 0<a<2); LiₐNi_{b}Co_{c}L¹_{d}GₑO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); Li_{(3-f)}Fe₂(PO₄)₃ (0≤f≤2); and LiₐFePO₄ (0.90≤a≤1.8).

In the above formulas, A is Ni, Co, Mn, or a combination thereof; X is Al, Ni, Co, Mn, Cr, Fe, Mg, Sr, V, a rare earth element, or a combination thereof; D is O, F, S, P, or a combination thereof; G is Al, Cr, Mn, Fe, Mg, La, Ce, Sr, V, or a combination thereof; and L¹ is Mn, Al, or a combination thereof.

In an example, the cathode material may be a high nickel-content cathode material containing 80 mol % or more, 85 mol % or more, 90 mol % or more, 91 mol % or more, or 94 mol % to 99 mol % of nickel relative to 100 mol % of metal excluding lithium in the lithium transition metal complex oxide. The high nickel-content cathode material can achieve high capacity and thus can be applied to high capacity/high density lithium secondary batteries.

In an embodiment, the cathode material may be present in an amount of 90 wt % to 99.5 wt % based on 100 wt % of the cathode material layer, and each of the binder and the conductive material may be present in an amount of 0.5 wt % to 5 wt % based on 100 wt % of the cathode material layer.

The binder serves to attach cathode material particles to each other while attaching the cathode material to the current collector. The binder may include, for example, polyvinyl alcohol, carboxymethylcellulose, hydroxypropylcellulose, diacetylcellulose, polyvinyl chloride, carboxylated polyvinyl chloride, polyvinyl fluoride, polymers including ethylene oxide, polyvinyl pyrrolidone, polyurethane, polytetrafluoroethylene, polyvinylidene fluoride, polyethylene, polypropylene, styrene-butadiene rubbers, (meth)acrylated styrene-butadiene rubbers, epoxy resins, (meth)acrylic resins, polyester resins, Nylon, and the like, without being limited thereto.

The conductive material imparts conductivity to the electrodes and may be any electrically conductive material that does not cause chemical change in cells under construction. The conductive material may include, for example, carbon materials, such as natural graphite, artificial graphite, carbon black, acetylene black, Ketjen black, carbon fiber, carbon nanofibers, carbon nanotubes, and the like; metal-based materials in the form of metal powders or metal fibers containing copper, nickel, aluminum, silver, and the like; conductive polymers, such as polyphenylene derivatives and the like; and mixtures thereof.

In an embodiment, the current collector may be aluminum, without being limited thereto.

The anode plate includes a current collector and an anode material layer formed on the current collector. The anode material layer includes an anode material and may further include a binder and/or a coating material.

The anode material includes a material allowing reversible intercalation/deintercalation of lithium ions, lithium metal, lithium metal alloy, a material capable of being doped to lithium and de-doped therefrom, or a transition metal oxide.

The material allowing reversible intercalation/deintercalation of lithium ions may include a carbon-based anode material, for example, crystalline carbon, amorphous carbon, or a combination thereof. The crystalline carbon may include, for example, graphite, such as natural graphite or artificial graphite, in amorphous, plate, flake, spherical, or fibrous form, and the amorphous carbon may include, for example, soft carbon, hard carbon, mesoporous pitch carbides, calcined coke, and the like.

The lithium metal alloy may be an alloy of lithium, and a metal selected from among Na, K, Rb, Cs, Fr, Be, Mg, Ca, Sr, Si, Sb, Pb, In, Zn, Ba, Ra, Ge, Al and Sn may be used.

The material capable of being doped to lithium and de-doped therefrom may be an Si-based anode material or an Sn-based anode material. The Si-based anode material may be silicon, a silicon-carbon composite, SiOₓ (0<x<2), Si-Q alloys (where Q is selected from among alkali metals, alkali-earth metals, Group XIII elements, Group XIV elements (excluding Si), Group XV elements, Group XVI elements, transition metals, rare-earth elements, and combinations thereof), or combinations thereof. The Sn-based anode material may be Sn, SnO₂, an Sn alloy, or a combination thereof.

The silicon-carbon composite may be a composite of silicon and amorphous carbon. According to an embodiment, the silicon-carbon composite may be prepared in the form of silicon particles and an amorphous carbon coating on the surface of the silicon particle. For example, the silicon-carbon composite may include secondary particles (cores) composed of primary silicon particles and an amorphous carbon coating layer (shell) formed on the surface of the secondary particle. The amorphous carbon may also be placed between the primary silicon particles such that, for example, the primary silicon particles are coated with amorphous carbon. The secondary particles may be dispersed in an amorphous carbon matrix.

The silicon-carbon composite may further include crystalline carbon. For example, the silicon-carbon composite may include a core containing crystalline carbon and silicon particles, and an amorphous carbon coating layer formed on the core.

The Si-based anode material or the Sn-based anode material may be used in combination with the carbon-based anode material.

In an embodiment, for example, the anode material layer can include 90 wt % to 99 wt % of the anode material, 0.5 wt % to 5 wt % of the binder, and 0 wt % to 5 wt % of the conductive material.

The binder serves to attach the anode material particles to each other while attaching the anode material to the current collector. The binder may be a non-aqueous binder, an aqueous binder, a dry binder, or a combination thereof.

The non-aqueous binder includes polyvinyl chloride, carboxylated polyvinyl chloride, polyvinyl fluoride, ethylene propylene copolymers, polystyrene, polyurethane, polytetrafluoroethylene, polyvinylidene fluoride, polyethylene, polypropylene, polyamideimide, polyimide, or combinations thereof.

The aqueous binder may be selected from the group consisting of styrene-butadiene rubbers, (meth)acrylated styrene-butadiene rubbers, (meth)acrylonitrile-butadiene rubbers, (meth)acrylic rubbers, butyl rubbers, fluorinated rubbers, polyethylene oxide, polyvinyl pyrrolidone, polyepichlorohydrin, polyphosphazene, poly(meth)acrylonitrile, ethylene propylene diene copolymers, polyvinyl pyridine, chlorosulfonated polyethylene, latex, polyester resins, (meth)acryl resins, phenol resins, epoxy resins, polyvinyl alcohol, and combinations thereof.

When the aqueous binder is used as the anode binder, a cellulose-based compound capable of imparting viscosity may be further included. The cellulose-based compound may be a mixture of carboxymethylcellulose, hydroxypropyl methylcellulose, methylcellulose, or alkali metal salts thereof. The alkali metal may be Na, K, or Li.

The dry binder may be a fibrous polymeric material and may include, for example, polytetrafluoroethylene, polyvinylidene fluoride, a polyvinylidene fluoride-hexafluoropropylene copolymer, polyethylene oxide, or a combination thereof.

The conductive material imparts conductivity to the electrodes and may be any electronically conductive material that does not cause chemical change in cells under construction. In an embodiment, the conductive material may include, for example, carbon materials, such as natural graphite, artificial graphite, carbon black, acetylene black, Ketjen black, carbon fibers, carbon nanofibers, carbon nanotubes, and the like; metal-based materials in the form of metal powders or metal fibers containing copper, nickel, aluminum, silver, and the like; conductive polymers, such as polyphenylene derivatives and the like; or mixtures thereof.

In an embodiment, the anode current collector may be selected from copper foil, nickel foil, stainless steel foil, titanium foil, nickel foam, copper foam, a conductive metal-coated polymer base, and combinations thereof.

An electrode plate 200 is at least partially punched by an electrode manufacturing apparatus G.

To this end, the electrode manufacturing apparatus G includes punching units R, S. The punching units R, S include a first punching unit R for punching a portion of the electrode plate 200 into a curved surface and a second punching unit S for punching another part of the electrode plate 200 into a straight surface. The first punching unit R and the second punching unit S may be driven concurrently (e.g., simultaneously) by a single driver. Thus, the electrode manufacturing apparatus G can form a curved surface and a straight surface on the electrode plate 200 by punching the electrode plate once.

The punching units R, S are devices for applying pressure to an object, such as the electrode plate 200, and require periodic polishing. However, such a polishing process requires a high processing cost, causing an increase in maintenance costs.

In addition, a connecting portion connecting the first punching unit R to the second punching unit S may suffer from occurrence of burrs. Such burrs can cause damage to the electrode plate. When such burrs are generated in the electrode manufacturing unit G, the electrode plate 200 and/or electrodes (for example, an anode, a cathode, and electrodes described in FIG. 1 to FIG. 4) manufactured by the electrode manufacturing unit G can damage a separator (for example, the separator described in FIG. 1 to FIG. 4) in a subsequent process of forming an electrode assembly.

The following description will focus on an electrode manufacturing apparatus and an electrode manufacturing method according to the present invention that can solve such problems.

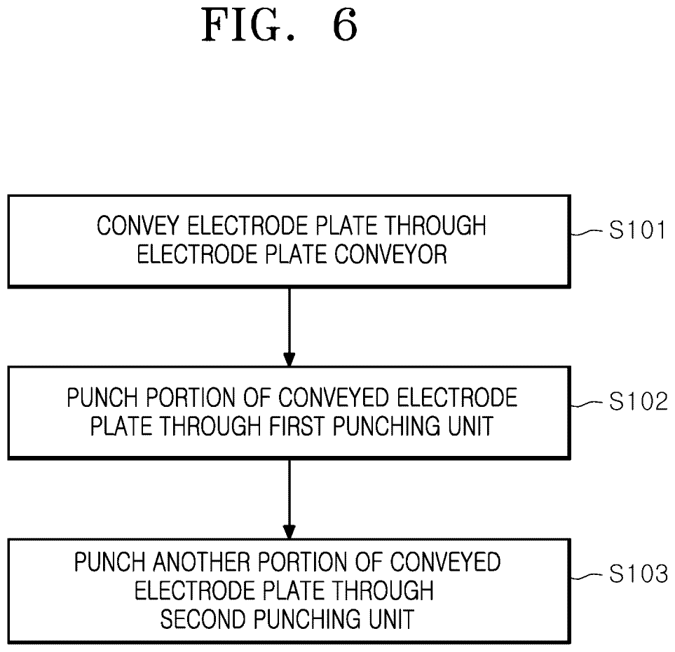

FIG. 6 is a flowchart illustrating an electrode manufacturing method according to an embodiment of the present invention.

To solve the problems described with reference to FIG. 5, for example, an embodiment of the present invention provides separation of a first electrode plate portion and a second electrode plate portion to drive a first punching unit and a second punching unit separately. A further detailed description thereof follows.

Referring to FIG. 6, an electrode manufacturing method according to an embodiment of the invention includes a step or task of conveying an electrode plate through an electrode plate conveyor (S101).

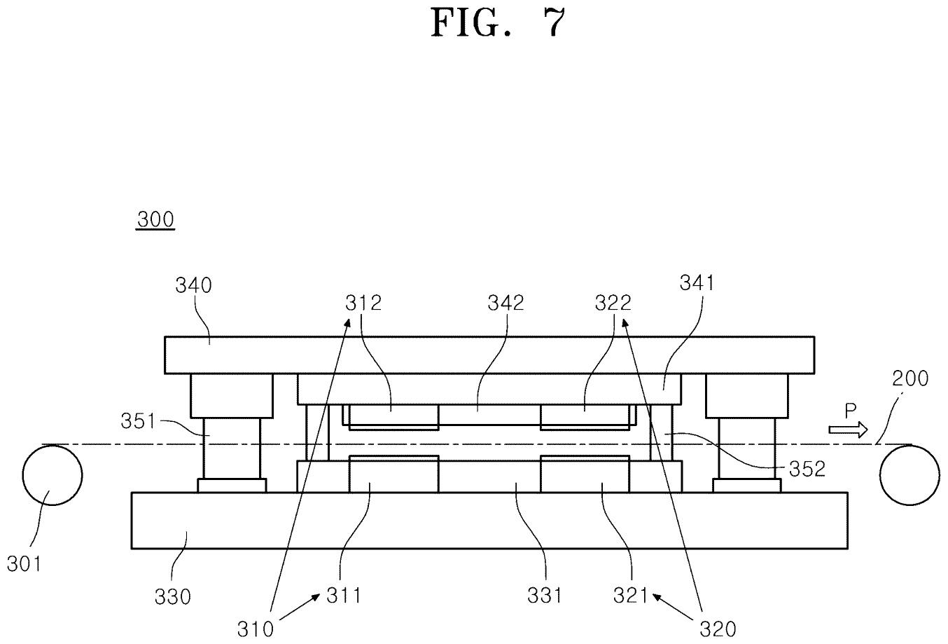

The electrode plate conveyor conveys the electrode plate 200 into an electrode manufacturing apparatus 300 (see FIG. 7) according to an embodiment of the present invention. In addition, the electrode plate conveyor allows the electrode plate 200 to be conveyed between components of the electrode manufacturing apparatus 300. For example, the electrode plate conveyor allows the electrode plate 200 to be conveyed from a first punching unit 310 (see FIG. 7) toward a second punching unit 320 (see FIG. 7).

Referring to FIG. 6, the electrode manufacturing method according to an embodiment includes a step or task of punching a portion of the conveyed electrode plate through the first punching unit (S102).

The first punching unit 310 includes a first shape. The first shape includes, for example, a curved portion.

The first punching unit 310 punches the electrode plate 200 corresponding to the first shape. Here, the first punching unit 310 may punch, for example, a single region and/or a plurality of regions of the electrode plate 200 as a portion thereof.

Referring to FIG. 6, the electrode manufacturing method according to an embodiment includes a step or task of punching another portion of the conveyed electrode plate through the second punching unit (S103).

The second punching unit 320 includes a second shape. The second shape is different from the first shape. For example, the second shape may include a straight portion. On the other hand, for example, when the first shape includes a straight portion, the second shape may include a curved portion. In this case, the straight portion of the electrode plate 200 is punched first and then the curved portion of the electrode plate 200 is punched. However, for convenience of description, the first shape includes the curved portion and the second shape includes the straight portion by way of example. In another embodiment, the second shape may be the same as or similar to the first shape.

The second punching unit 320 punches the electrode plate 200 corresponding to the second shape. Here, the second punching unit 320 may punch, for example, a single region and/or a plurality of regions of the electrode plate 200 as another portion thereof.

In an embodiment, the second punching unit 320 punches the electrode plate 200 that has been partially punched and cut by the first punching unit 310. Accordingly, the second punching unit 320 may be placed behind the first punching unit 310 in a conveying direction of the electrode plate 200. That is, a portion of the electrode plate 200 is cut by the first punching unit 310 and then another portion of the electrode plate 200 is cut by the second punching unit 320.

In an embodiment, the second punching unit 320 may punch a portion of the electrode plate 200 that is continuous with the portion of the electrode plate 200 punched by the first punching unit 310. In another embodiment, the second punching unit 320 may punch a portion of the electrode plate 200 that is discontinuous with the portion of the electrode plate 200 punched by the first punching unit 310.

As such, the electrode manufacturing method according to an embodiment allows the first punching unit 310 and the second punching unit 320 to be separately driven in sequence, thereby preventing or substantially preventing burrs from occurring at a connecting portion where the first punching unit 310 is connected to the second punching unit 320.

On the other hand, burr management, such as polishing, may be desired only for a punching unit that includes a curved portion (for example, a circular shape). According to an embodiment of the present invention, burr management may be desired only for one of the first punching unit 310 and the second punching unit 320. Accordingly, the electrode manufacturing method according to an embodiment can reduce a time for polishing the punching units and/or processing costs.

Next, an electrode manufacturing apparatus to which such an electrode manufacturing method is applicable will be described.

FIG. 7 is a schematic cross-sectional view of an electrode manufacturing apparatus according to an embodiment of the present invention.

In FIG. 7, reference numeral 300 denotes an electrode manufacturing apparatus 300 according to an embodiment of the present invention. As described above, the electrode manufacturing apparatus 300 punches at least a portion of the electrode plate 200.

The electrode manufacturing apparatus 300 includes an electrode plate conveyor 301, a first punching unit 310, and a second punching unit 320. In addition, the electrode manufacturing apparatus 300 may further include additional components to assist these components. For example, the electrode manufacturing apparatus 300 may further include at least one of a lower base 330, an upper base 340, and guides 351, 352.

The electrode plate conveyor 301 conveys the electrode plate 200.

The first punching unit 310 punches a portion of the electrode plate 200 conveyed by the electrode plate conveyor 301. In an embodiment, the first punching unit 310 includes a first die 311 and a first punch 312.

In an embodiment, the first die 311 includes a groove (not shown). The first die 311 includes, for example, a groove corresponding to the first shape described in FIG. 6. For example, the first die 311 includes a groove in which at least a portion of a cross-section of the first die 311 perpendicular to a moving direction of the first punching unit 310 (or a cross-section of the first die 311 parallel to the conveying direction of the electrode plate 200) is formed as a curved surface.

The first die 311 may include a single groove or a plurality of grooves. In an embodiment, the first die 311 includes a plurality of grooves, and the grooves may be spaced apart from each other. In another embodiment, at least two of the plurality of grooves may be continuous with each other.

The plurality of grooves includes, for example, a curved tap die that forms a curved groove in the electrode plate 200. In another embodiment, the plurality of grooves includes, for example, a V-shaped cutting die that forms a curved groove and/or a V-shaped groove.

The first punch 312 is formed in a shape corresponding to the groove formed in the first die 311. The first punch 312 includes, for example, a shape corresponding to the first shape described in FIG. 6. For example, the first punch 312 may include a pillar (or a rod, a bar, or a protrusion) in which at least a portion of a cross-section of the first punch 312 perpendicular to the moving direction of the first punching unit 310 (or a cross-section of the first punch 312 parallel to the conveying direction P of the electrode plate 200) is formed as a curved surface.

The first punch 312 may include a single pillar or a plurality of pillars. In an embodiment, the first punch 312 includes a plurality of pillars, and the pillars may be spaced apart from each other. In another embodiment, at least two of the plurality of pillars may be continuous with each other.

In an embodiment, the plurality of pillars includes, for example, a curved tap punch, which is formed corresponding to the curved tap die forming the curved groove in the electrode plate 200 and is insertable into the curved tap die. In another embodiment, the plurality of pillars may include, for example, a V-shaped cutting punch, which is formed corresponding to the V-shaped cutting die forming the curved groove and/or the V-shaped groove in the electrode plate 200 and is insertable into the V-shaped cutting die.

The first punch 312 may be inserted into the first die 311. For example, the first punch 312 may be inserted into the first die 311 through downward movement of the first punch 312. In another embodiment, the first punch 312 may be inserted into the first die 311 through upward movement of the first die 311. In another embodiment, the first punch 312 may be inserted into the first die 311 through upward movement of the first die 311 and downward movement of the first punch 312. Here, the upward movement and/or the downward movement is performed in a direction perpendicular to the conveying direction P of the electrode plate 200.

As such, the first punch 312 is inserted into the first die 311 to allow the first punching unit 310 to punch a portion of the electrode plate 200 placed between the first die 311 and the first punch 312. For example, the curved tab punch is inserted into the curved tab die to allow the first punching unit 310 to form a curved portion of the tab as a surface of the tab of the electrode plate 200. In another embodiment, the V-shaped cutting punch may be inserted into the V-shaped cutting die to allow the first punching unit 310 to form a V-shaped groove in the electrode plate 200 at an edge thereof.

The second punching unit 320 punches another portion of the electrode plate 200 that has been punched by the first punching unit 310 and then conveyed by the conveyor 301. In an embodiment, the second punching unit 320 includes a second die 321 and a second punch 322.

The second die 321 includes a groove. The second die 321 includes, for example, a groove corresponding to the second shape described in FIG. 6. For example, the second die 321 includes a groove in which at least a portion of a cross-section of the second die 321 perpendicular to a moving direction of the second punching unit 320 (or a cross-section of the second die 321 parallel to the conveying direction of the electrode plate 200) is formed as a planar surface (a straight surface or a flat surface).

The second die 321 may include a single groove or a plurality of grooves. In an embodiment, the second die 321 includes a plurality of grooves, and the grooves may be spaced apart from each other. In another embodiment, at least two of the plurality of grooves may be continuous with each other.

In an embodiment, the plurality of grooves includes, for example, a planar tap die that forms a planar groove in the electrode plate 200. In another embodiment, the plurality of grooves includes, for example, a straight cutting die that forms another planar groove.

The second punch 322 is formed in a shape corresponding to the groove formed in the second die 321. The second punch 322 includes, for example, a shape corresponding to the second shape described in FIG. 6. In an embodiment, for example, the second punch 322 includes a pillar (or a rod, a bar, or a protrusion) in which at least a portion of a cross-section of the second punch 322 perpendicular to the moving direction of the second punching unit 320 (or a cross-section of the second punch 322 parallel to the conveying direction P of the electrode plate 200) is formed as a planar surface.

The second punch 322 may include a single pillar or a plurality of pillars. In an embodiment, the second punch 322 includes a plurality of pillars, and the pillars may be spaced apart from each other. In another embodiment, at least two of the plurality of pillars may be continuous with each other.

In an embodiment, the plurality of pillars includes, for example, a planar tap punch, which is formed corresponding to the planar tap die forming the planar groove in the electrode plate 200 and is insertable into the planar tap die. In another embodiment, the plurality of pillars may include, for example, a straight cutting punch, which is formed corresponding to the straight cutting die forming another planar groove in the electrode plate 200 and is insertable into the straight cutting die.

The second punch 322 may be inserted into the second die 321. For example, the second punch 322 is inserted into the second die 321 through downward movement of the second punch 322. In another embodiment, the second punch 322 may be inserted into the second die 321 through upward movement of the second die 321. In another embodiment, the second punch 322 may be inserted into the second die 321 through upward movement of the second die 321 and downward movement of the second punch 322. Here, the upward movement and/or the downward movement is performed in a direction perpendicular to the conveying direction P of the electrode plate 200.

As such, the second punch 322 is inserted into the second die 321 to allow the second punching unit 320 to punch a portion of the electrode plate 200 placed between the second die 321 and the second punch 322. For example, the planar tab punch is inserted into the planar tab die, thereby allowing the second punching unit 320 to form a planar portion of the tab as a surface of the tab of the electrode plate 200. In another embodiment, the straight cutting punch may be inserted into the straight cutting die to allow the second punching unit 320 to form a flat surface of the electrode plate 200 at a side thereof.

The lower base 330 is located at a lower portion of the electrode manufacturing apparatus 300 and supports the lower portion of the electrode manufacturing apparatus 300. For example, the lower base 330 supports dies (including, for example, the first die 311 and the second die 321) placed at the lower portion of the electrode manufacturing apparatus 300. In an embodiment, the lower base 330 includes a die plate 331 on at least one surface of the lower base 330. The die plate 331 provides a space in which the dies 311, 321 are arranged. For example, the die plate 331 guides a traveling path of the dies 311, 321 and/or prevents or substantially prevents the dies 311, 312 from deviating from the traveling path due to pressure.

In an embodiment, each of the dies 311, 321 may be separated from the die plate 331. This structure allows each of the dies 311, 321 to be individually disassembled and/or easily managed.

The upper base 340 is located at an upper portion of the electrode manufacturing apparatus 300 and supports the upper portion of the electrode manufacturing apparatus 300. For example, the upper base 340 supports punches (including, for example, the first punch 312 and the second punch 322) placed at the upper portion of the electrode manufacturing apparatus 300. When the dies 311, 321 are placed at the upper portion of the electrode manufacturing apparatus 300 and are supported by the upper base 340, the punches 312, 322 may be placed at the lower portion thereof and supported by the upper base 340. In an embodiment, the upper base 340 includes a punch plate 341 on at least one surface of the upper base 340. The punch plate 341 provides a space in which the punches 312, 322 are arranged. For example, the punch plate 341 guides a traveling path of the punches 312, 322 and/or prevents or substantially prevents the punches 311, 312 from deviating from the traveling path due to pressure.

In an embodiment, each of the punches 311, 312 may be separated from the punch plate 341. This structure allows each of the punches 311, 312 to be individually disassembled and/or easily managed.

In an embodiment, the upper base 340 may further include a stripper 342 that presses and/or secures the electrode plate 200 such that the electrode plate 200 is secured to the electrode manufacturing apparatus 300.

The guides 351, 352 allow the electrode plate 200 to move in a certain direction (e.g., a preset direction) within the electrode manufacturing apparatus 300. In other words, the guides 351, 352 prevent or substantially prevent the electrode plate 200 from moving or deviating from a certain path (e.g., a preset path).

The guides 351, 352 include a first guide 351 and a second guide 352. The first guide 351 is formed between the lower base 330 and the upper base 340. The first guide 351 supports the lower base 330 and/or the upper base 340. In another embodiment, the first guide 351 guides movement of the lower base 330 and/or the upper base 340. The second guide 352 is formed between the die plate 331 and the punch plate 341. The second guide 352 supports the die plate 331 and/or the punch plate 332. In another embodiment, the second guide 352 guides movement of the die plate 331 and/or the punch plate 332.

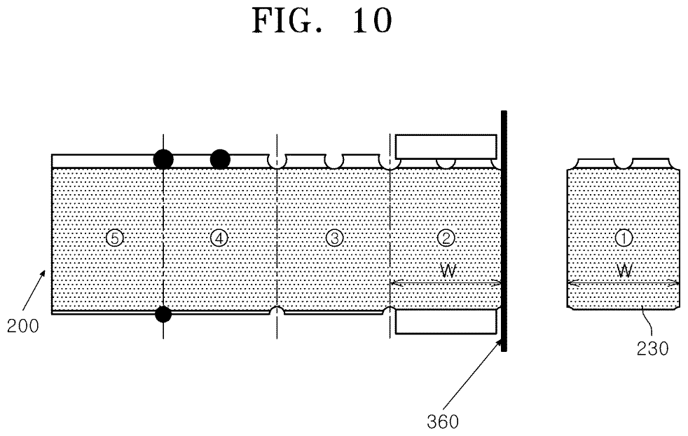

Although not shown in FIG. 7, the electrode manufacturing apparatus 300 may further include a cutting unit. The cutting unit cuts the electrode plate 200 at unit intervals to form an electrode 230 (see FIG. 10). For example, the cutting unit cuts the electrode plate 200, which is punched at a portion thereof by the first punching unit 310 and at another portion thereof by the second punching unit 320, at unit intervals to form the electrodes 230. Here, the unit interval refers to a certain distance (e.g., a preset distance) set according to a width w (see FIG. 10) desired for the electrode 230. In an embodiment, the cutting unit may cut the electrode plate 200 first depending on arrangement of the cutting unit. Here, the electrode plate 200 may be punched by the first punching unit 310 and the second punching unit 320 after being cut by the cutting unit.

With these components, the electrode manufacturing apparatus 300 according to an embodiment of the present invention allows sequential operation of the first punching unit 310 and the second punching unit 320 by separating the first punching unit 310 and the second punching unit 320 from each other. As a result, the electrode manufacturing apparatus 300 can prevent or substantially prevent occurrence of burrs at the connecting portion between the first punching unit 310 and the second punching unit 320. Further, the electrode manufacturing apparatus 300 can reduce a time for grinding the punching units and/or manufacturing costs.

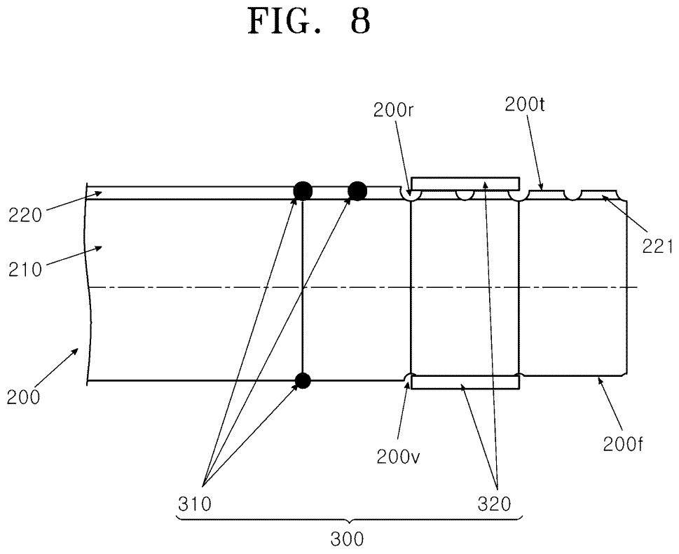

FIG. 8 is a schematic view of a punched electrode plate according to an embodiment of the present invention.

As described with reference to FIG. 5, the electrode plate 200 includes a substrate and an active material layer formed on the substrate. Here, a portion of the electrode plate 200 in which the active material layer is formed on the substrate is referred to as a coated portion 210. In addition, a portion of the electrode plate 200 in which the active material layer is not formed on the substrate is referred to as an uncoated portion 220. As shown in FIG. 8, the electrode plate 200 includes the coated portion 210 and the uncoated portion 220.

The first punching unit 310 punches, for example, at least a portion of the uncoated portion 220. A portion of the uncoated portion 220 may be an edge of the electrode plate 200. The edge of the electrode plate 200 may be placed in a direction perpendicular to the conveying direction P of the electrode plate 200. The edge of the electrode plate 200 is, for example, a portion of an edge of a unit electrode plate (for example, \textcircled{1} in FIG. 10). However, the edge of the electrode plate 200 may be a portion of an edge placed between unit electrode plates (for example, \textcircled{1} and \textcircled{2} in FIG. 10). Thus, the first punching unit 310 forms a curved portion 200r of the tab at a portion of the uncoated portion 220.

In another embodiment, the first punching unit 310 punches, for example, at least a portion of the uncoated portion 220 and/or the coated portion 210. A portion of the uncoated portion 220 and/or the coated portion 210 may be an edge of the electrode plate 200. The edge of the electrode plate 200 may be placed in a direction perpendicular to the conveying direction P of the electrode plate 200. The edge of the electrode plate 200 is, for example, a portion of an edge placed between unit electrode plates (for example, \textcircled{1} and \textcircled{2} in FIG. 10). Here, a portion of the uncoated portion 220 and/or the coated portion 210 may be an edge placed opposite to at least a portion of the uncoated portion 220. In an embodiment, with this structure, the first punching unit 310 forms a V-shaped groove 200v in the electrode plate 200. The first punching unit 310 may form the curved portion 200r of the tab at an end of the electrode plate 200 while forming the V-shaped groove 200v at another end of the electrode plate 200 through a single punching operation.

The second punching unit 320 punches the electrode plate 200 after the first punching unit 310 punches the electrode plate 200.

The second punching unit 320 punches, for example, a portion of the uncoated portion 220. The portion of the uncoated portion 220 may be an edge of the electrode plate 200, for example, an edge of the uncoated portion 220. Accordingly, the second punching unit 320 forms a planar portion 200t of the tab at an end of the uncoated portion 220. The planar portion 200t of the tab may be connected to a side of the curved portion 200r of the tab. Here, the tab may be formed on the uncoated portion 220 by the curved portion 200r and the planar portion 200t of the tab. In addition, the second punching unit 320 may punch, for example, a portion of the uncoated portion 220 and/or the coated portion 210. In an embodiment, the portion of the uncoated portion 220 and/or the coated portion 210 may include an entirety of the uncoated portion 220 (in this case, the portion may include a portion of the coated portion 210) or a portion of the uncoated portion 220 (in this case, the portion may not include the coated portion 210) formed at a lower portion of the electrode plate 200. Accordingly, the second punching unit 320 cuts, for example, the uncoated portion 220 at the lower portion of the electrode plate 200 such that the lower end of the electrode plate 200 becomes a flat straight surface 200f. The second punching unit 320 may form the planar portion 200t at an upper portion of the tab and the flat surface 200f at the lower end of the electrode plate 200 through a single punching operation.

As such, electrodes manufactured by the manufacturing apparatus according to an embodiment of the present invention have reduced burrs.

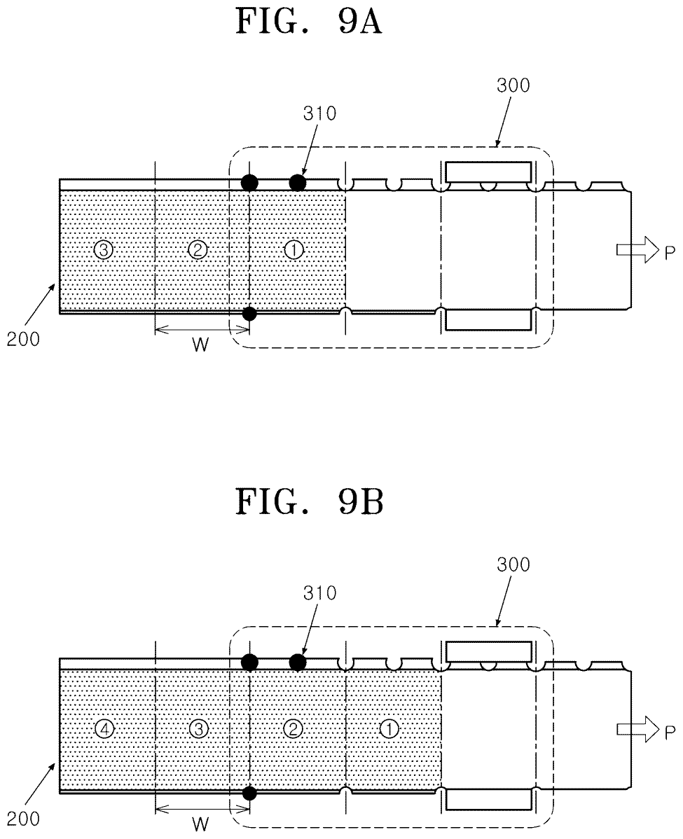

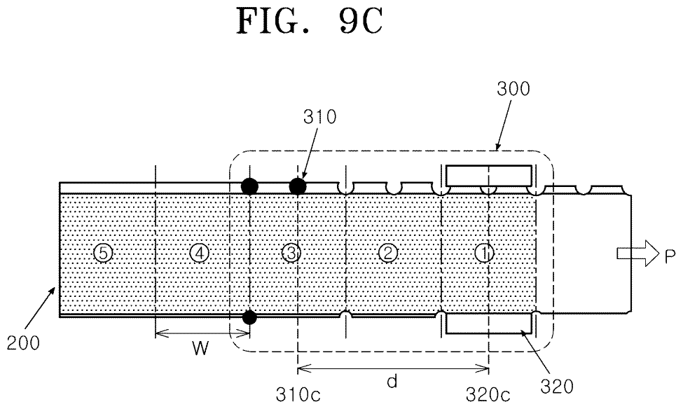

FIG. 9A to FIG. 9C are diagrams illustrating a process of manufacturing an electrode according to an embodiment of the present invention.

In FIG. 9A to FIG. 9C, arrangement and/or punching spacing of the first punching unit 310 and the second punching unit 320 described with reference to FIG. 6 to FIG. 8 will be described. In an embodiment, in FIG. 9A to FIG. 9C, the electrode plate 200 is conveyed in the conveying direction P with respect to the electrode manufacturing apparatus 300.

FIG. 9A shows the first punching unit 310 punching a portion of the electrode plate 200. FIG. 9B shows the electrode plate 200 being conveyed by the first punching unit 310 toward the second punching unit 320. FIG. 9C shows the second punching unit 320 punching another portion of the electrode plate 200.

The first punching unit 310 and the second punching unit 320 are spaced apart by a distance, or certain distance, d (e.g., a predetermined distance) from each other to be operated sequentially and separately, as described above. Here, the distance d is a distance between a center line 310c of the first punching unit 310 and a center line 320c of the second punching unit 320. Here, each of the center lines 310c, 320c of the first and second punching units 310, 320 bisects a corresponding punching unit 310 or 320 with reference to the conveying direction P of the electrode plate 200. The distance d is an integer (integer greater than or equal to 1) times a unit interval W of the electrode plate 200 in the movement direction P of the electrode plate 200.

In an embodiment, the distance d is defined in the case in which the center line 310c or 320c of each of the first and second punching units 310, 320 coincides with the center line of the unit interval of each of the electrode plates. For example, the center line of a third electrode plate \textcircled{3} may not coincide with the center line 320c of the second punching unit 320. Here, the distance d is a real number (real number greater than or equal to 1) times the unit interval W of the electrode plate 200 in the conveying direction P of the electrode plate 200.

Then, the first punching unit 310 and/or the second punching unit 320 performs a punching operation every n times a time for which the electrode plate 200 is conveyed by the unit interval W of the electrode plate. Here, n indicates a value obtained by dividing the distance d by the unit interval W of the electrode plate. Here, as described with reference to FIG. 7, the unit interval W is a spacing (e.g., a preset spacing) set according to the width (for example, W) required for the electrode 230. In other words, the unit interval W is a pitch of one electrode.

For example, the unit interval W of the electrode plate may be 1 and the distance d may be 2. Here, n is 2. In this case, the first punching unit 310 and/or the second punching unit 320 performs a punching operation every two times a time for which the electrode plate 200 is conveyed by the unit interval W of the electrode plate.

Thus, the electrode manufacturing apparatus according to an embodiment of the present invention can sequentially perform punching operation while conveying the electrode plate 200.

FIG. 10 is a diagram illustrating a process of manufacturing an electrode according to an embodiment of the present invention.

FIG. 10 shows a process of cutting the punched electrode plate 200 shown in FIG. 9A to FIG. 9C. As described in FIG. 7, the electrode manufacturing apparatus 300 according to an embodiment of the present invention further includes a cutting unit.

In an embodiment, an electrode may be applied to a cell in a jelly roll shape. Here, the electrode manufacturing apparatus 300 may form the electrode without cutting the electrode plate 200.

In another embodiment, the electrodes may be applied to the cell in a cut and stacked shape. In this case, a cutting unit 360 cuts the electrode plate 200 at a unit interval W. The unit spacing W is the same as or similar to that described in FIG. 7 or FIG. 9A to FIG. 9C.

As a result, the electrode manufacturing device 300 can manufacture electrodes 230 that minimize or reduce the occurrence of burrs.

Although the present invention has been described with reference to some embodiments and drawings illustrating aspects thereof, the present invention is not limited thereto. Various modifications and variations can be made by a person skilled in the art to which the present invention belongs within the scope of the technical spirit of the invention and the claims and equivalents thereto.

What is claimed is:

1. An electrode manufacturing apparatus comprising:
an electrode plate conveyor to convey an electrode plate;
a first punching unit configured to punch a portion of the electrode plate conveyed by the electrode plate conveyor; and
a second punching unit configured to punch another portion of the electrode plate punched by the first punching unit and conveyed by the electrode plate conveyor.

2. The electrode manufacturing apparatus as claimed in claim 1, wherein the second punching unit is arranged behind the first punching unit in a conveying direction of the electrode plate.

3. The electrode manufacturing apparatus as claimed in claim 1, wherein the first punching unit comprises a first shape, and the second punching unit comprises a second shape different from the first shape.

4. The electrode manufacturing apparatus as claimed in claim 1, wherein the first punching unit comprises a curved portion, and the second punching unit comprises a straight portion.

5. The electrode manufacturing apparatus as claimed in claim 1, wherein the first punching unit comprises:
a first die comprising a curved tab die to form a surface of a tab of the electrode plate, and a V-shaped cutting die to form a V-shaped groove on the electrode plate; and
a first punch comprising a curved tab punch corresponding to the curved tab die and insertable into the curved tab die to form the surface of the tab, and a V-shaped cutting punch corresponding to the V-shaped cutting die and insertable into the V-shaped cutting die to form the V-shaped groove.

6. The electrode manufacturing apparatus as claimed in claim 1, wherein the second punching unit comprises:
a second die comprising a planar tap die to form another surface of a tab of the electrode plate, and a straight cutting die to form a flat surface of the electrode plate at a side thereof; and
a second punch comprising a planar tap punch corresponding to the planar tap die and insertable into the planar tap die to form the another surface of the tab, and a straight cutting punch corresponding to the straight cutting die and insertable into the straight cutting die to form the flat surface of the electrode plate at the side thereof.

7. The electrode manufacturing apparatus as claimed in claim 1, wherein the first punching unit and the second punching unit are spaced apart from each other by a certain distance, the certain distance being an integer times a unit interval of the electrode plate with respect to a conveying direction of the electrode plate.

8. The electrode manufacturing apparatus as claimed in claim 7, wherein at least one of the first punching unit and the second punching unit performs punching every n times a time for which the electrode plate is conveyed by the unit interval of the electrode plate.

9. The electrode manufacturing apparatus as claimed in claim 7, wherein n is a value obtained by dividing the certain distance by the unit interval of the electrode plate.

10. The electrode manufacturing apparatus as claimed in claim 7, further comprising:
a cutting unit to cut the electrode plate at unit intervals of the electrode plate to manufacture electrodes.

11. An electrode manufacturing method comprising:
conveying an electrode plate via an electrode plate conveyor;
punching a portion of the conveyed electrode plate via a first punching unit;
punching another portion of the electrode plate punched by the first punching unit and conveyed by the electrode plate conveyer via a second punching unit.

12. The electrode manufacturing method as claimed in claim 11, wherein the first punching unit comprises a first shape, and the second punching unit comprises a second shape different from the first shape.

13. The electrode manufacturing method as claimed in claim 11,
wherein the first punching unit comprises:
a first die comprising a curved tab die to form a surface of a tab of the electrode plate, and a V-shaped cutting die to form a V-shaped groove on the electrode plate; and
a first punch comprising a curved tab punch corresponding to the curved tab die and insertable into the curved tab die to form the surface of the tab, and a V-shaped cutting punch corresponding to the V-shaped cutting die and insertable into the V-shaped cutting die to form the V-shaped groove, and
wherein the second punching unit comprises:
a second die comprising a planar tap die to form another surface of the tab of the electrode plate, and a straight cutting die to form a flat surface of the electrode plate at a side thereof; and
a second punch comprising a planar tap punch corresponding to the planar tap die and insertable into the planar tap die to form the another surface of the tab, and a straight cutting punch corresponding to the straight cutting die and insertable into the straight cutting die to form the flat surface of the electrode plate at the side thereof.

14. The electrode manufacturing method as claimed in claim 11, wherein the punching the another portion of the electrode plate via the second punching unit comprises:
punching the another portion of the electrode plate after n times a time for which the electrode plate is conveyed by a unit interval of the electrode plate after a portion of the electrode plate has been punched through the first punching unit, n being a value obtained by dividing a distance between the first punching unit and the second punching unit by the unit interval of the electrode plate.

15. The electrode manufacturing method as claimed in claim 11, further comprising:
cutting the electrode plate at unit intervals to manufacturing electrodes after the portion and the another portion of the electrode plate are punched.
